(19) United States
(12) Patent Application Publication
(10) Pub. No.: US 2014/0186005 A1
(43) Pub. Date: Jul. 3, 2014

(54) DISPLAY CONTROL APPARATUS THAT DISPLAYS IMAGE CORRESPONDING TO PREDETERMINED MOTION

(71) Applicant: Casio Computer Co., Ltd., Tokyo (JP)

(72) Inventors: Tatsunori TAKAGI, Tokyo (JP); Hiroyuki KATO, Tokyo (JP); Katsunori TSUTSUMI, Tokyo (JP); Toshihiko YOSHIDA, Tokyo (JP); Jun MURAKI, Tokyo (JP)

(73) Assignee: Casio Computer Co., Ltd., Tokyo (JP)

(21) Appl. No.: 14/139,632

(22) Filed: Dec. 23, 2013

(30) Foreign Application Priority Data
Dec. 28, 2012 (JP) 2012-288972

(51) Int. Cl. H04N 9/87; G11B 27/00

(52) U.S. Cl. CPC H04N 9/87; G11B 27/005
USPC 386/224

(57) ABSTRACT

An image capture apparatus (1) includes a frame search unit (97), a swing state judgment unit (96), and a display control unit (98). The swing state judgment unit (96) identifies a current posture in a sequence of motions of a swing person (SP). The frame search unit (97) searches for an image corresponding to the current posture identified by the swing state judgment unit (96) from a moving image as a search target. The display control unit (98) causes a display to display an image found by the frame search unit (97).

This application is based on and claims the benefit of priority from Japanese Patent Application No. 2012-288972, filed on 28 Dec. 2012, the content of which is incorporated herein by reference.

### BACKGROUND OF THE INVENTION

1. Field of the Invention

The present invention relates to a display control apparatus that displays an image corresponding to a predetermined motion, a display control method, and a storage medium.

2. Related Art

As a conventional technology, Japanese Unexamined Patent Application, Publication No. 2008-80098 discloses a technology that allows a player to learn a swing by swinging to match a swing image of a good model by instructing the start of a swing, in order to reinforce functional effects of a trunk of the body in exercises such as a hitting motion in golf, baseball, tennis, volleyball, etc.

### SUMMARY OF THE INVENTION

According to an aspect of the present invention, a display control apparatus is provided which includes: a moving image acquisition unit that acquires a first moving image of a sequence of motions of a first subject; an identification unit that identifies a current posture in a sequence of motions of a second subject; an image acquisition unit that acquires, from the first moving image, an image corresponding to the current posture; and a first display control unit that causes a display to display the acquired image acquired by the image acquisition unit. According to another aspect of the present invention, a display control method is provided which includes: acquiring a moving image of a sequence of motions of a first subject; identifying a current posture in a sequence of motions of a second subject; acquiring, from the moving image, an image corresponding to the current posture; and causing a display to display the image acquired by the image acquisition unit. According to still another aspect of the present invention, provided is a non-transitory storage medium encoded with a computer-readable program that enables a computer to execute functions as: a moving image acquisition unit that acquires a moving image of a sequence of motions of a first subject; an identification unit that identifies a current posture in a sequence of motions of a second subject; an image acquisition unit that acquires, from the moving image, an image corresponding to the current posture; and a first display control unit that causes a display to display the image acquired by the image acquisition unit.

### BRIEF DESCRIPTION OF THE DRAWINGS

FIG. 1 is a block diagram showing a hardware configuration of an image capture apparatus according to a first embodiment of the present invention;

FIG. 2 is a schematic diagram showing an outline of a utilization form of an image capture apparatus having the hardware configuration of FIG. 1;

FIG. 3 is a schematic diagram showing a general outline of a display on an output unit;

FIG. 4 is a schematic diagram showing a specific example of a method for cueing and playback;

FIG. 5 is a functional block diagram showing a functional configuration for executing cueing and playback processing among the functional configurations of the image capture apparatus of FIG. 1;

FIG. 6A is a schematic view for explaining an instruction area;

FIG. 6B is a schematic view for explaining an instruction area;

FIG. 7 is a flowchart explaining a flow of cueing and playback processing executed by the image capture apparatus of FIG. 1 having the functional configuration of FIG. 5;

FIG. 8 is a block diagram showing a hardware configuration of an image capture apparatus according to a second embodiment of the present invention;

FIG. 9A is a schematic diagram showing an outline of a utilization form of an image capture apparatus having a hardware configuration of FIG. 8;

FIG. 9B is a schematic diagram showing an outline of a utilization form of an image capture apparatus having a hardware configuration of FIG. 8;

FIG. 10A is a schematic diagram illustrating an identification of a swing;

FIG. 10B is a schematic diagram illustrating an identification of a swing;

FIG. 11 is a schematic diagram illustrating specific details of a swing motion;

FIG. 12 is a functional block diagram showing a functional configuration for executing swing setting processing of interlock display mode processing among the functional configurations of the image capture apparatus of FIG. 8;

FIG. 13 is a functional block diagram showing a functional configuration for executing interlock display processing of the interlock display mode processing among the functional configuration of the image capture apparatus of FIG. 8;

FIG. 14 is a flowchart showing a flow of swing setting processing in the interlock display mode processing; and

FIG. 15 is a flowchart showing a flow of the interlock display processing in the interlock display mode processing.

### DETAILED DESCRIPTION OF THE INVENTION

In the following, embodiments of the present invention are explained with reference to the drawings.

### First Embodiment

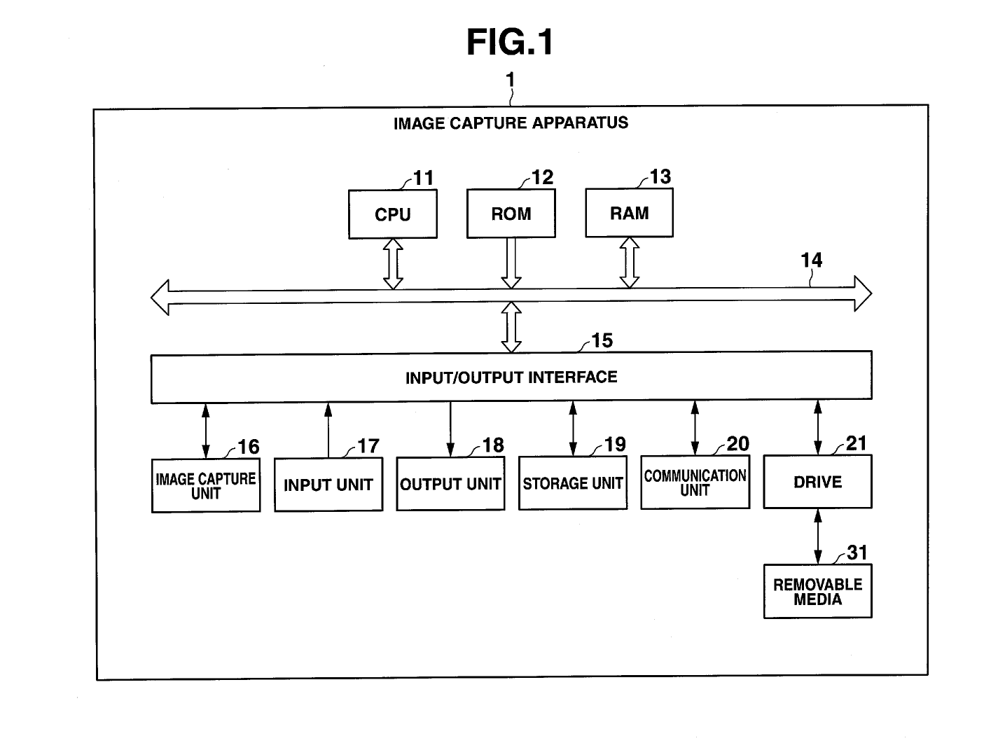

FIG. 1 is a block diagram showing a hardware configuration of an image capture apparatus 1 according to an embodiment of the present invention.

The image capture apparatus 1 is configured as, for example, a digital camera.

The image capture apparatus 1 includes a CPU (Central Processing Unit) 11, ROM (Read Only Memory) 12, RAM (Random Access Memory) 13, bus 14, an Input/Output interface 15, an image capture unit 16, an input unit 17, an output unit 18, a storage unit 19, a communication unit 20, and a drive 21.

The CPU 11 executes various processing according to programs that are recorded in the ROM 12, or programs that are loaded from the storage unit 19 to the RAM 13.

The RAM 13 also stores data and the like necessary for the CPU 11 to execute the various processing, as appropriate.

The CPU 11, the ROM 12 and the RAM 13 are connected to one another via the bus 14. The input/output interface 15 is also connected to the bus 14. The image capture unit 16, the input unit 17, the output unit 18, the storage unit 19, the communication unit 20, and the drive 21 are connected to the input/output interface 15.

The image capture unit 16 includes an optical lens unit and an image sensor (not illustrated).

In order to photograph a subject, the optical lens unit is configured by a lens such as a focus lens and a zoom lens for condensing light.

The focus lens is a lens for forming an image of a subject on the light receiving surface of the image sensor. The zoom lens is a lens that causes the focal length to freely change in a certain range.

The optical lens unit also includes peripheral circuits to adjust setting parameters such as focus, exposure, white balance, and the like, as necessary.

The image sensor is configured by an optoelectronic conversion device, an AFE (Analog Front End), and the like.

The optoelectronic conversion device is configured by a CMOS (Complementary Metal Oxide Semiconductor) type of optoelectronic conversion device and the like, for example. Light incident through the optical lens unit forms an image of a subject in the optoelectronic conversion device. The optoelectronic conversion device optoelectronically converts (i.e. captures) the image of the subject, accumulates the resultant image signal for a predetermined time interval, and sequentially supplies the image signal as an analog signal to the AFE.

The AFE executes a variety of signal processing such as A/D (Analog/Digital) conversion processing of the analog signal. The variety of signal processing generates a digital signal that is output as an output signal from the image capture unit 16.

Such an output signal of the image capture unit 16 is hereinafter referred to as “data of a captured image”. Data of a captured image is supplied to the CPU 11, etc. as appropriate.

Furthermore, upon starting an image capture motion by the image capture unit equipped to the image capture apparatus 1, the data of a captured image is sequentially displayed on the output unit 18 as live view images sequentially outputted (hereinafter, referred to as “live view display”). Furthermore, photographing live view images is referred to as live view photographing.

The input unit 17 is configured by various buttons and inputs a variety of information in accordance with instruction operations by the user.

The output unit 18 is configured by the display unit, a speaker, and the like, and outputs images and sound.

The storage unit 19 is configured by DRAM (Dynamic Random Access Memory) or the like, and stores data of various images.

The communication unit 20 controls communication with other devices (not shown) via networks including the Internet.

In the image capture apparatus 1, it is arranged so that the direction of an image sensor of the image capture unit 16 and the direction of a display surface of the output unit 18 are the same. It should be noted that, in the image capture apparatus 1, it may be configured so that the image capture unit 16 and the output unit 18 can be changed so as to set the directions to be the same upon photographing by way of the image capture unit 16.

A removable medium 31 composed of a magnetic disk, an optical disk, a magneto-optical disk, semiconductor memory or the like is installed in the drive 21, as appropriate. Programs that are read via the drive 21 from the removable medium 31 are installed in the storage unit 19, as necessary. Similarly to the storage unit 19, the removable medium 31 can also store a variety of data such as the image data stored in the storage unit 19.

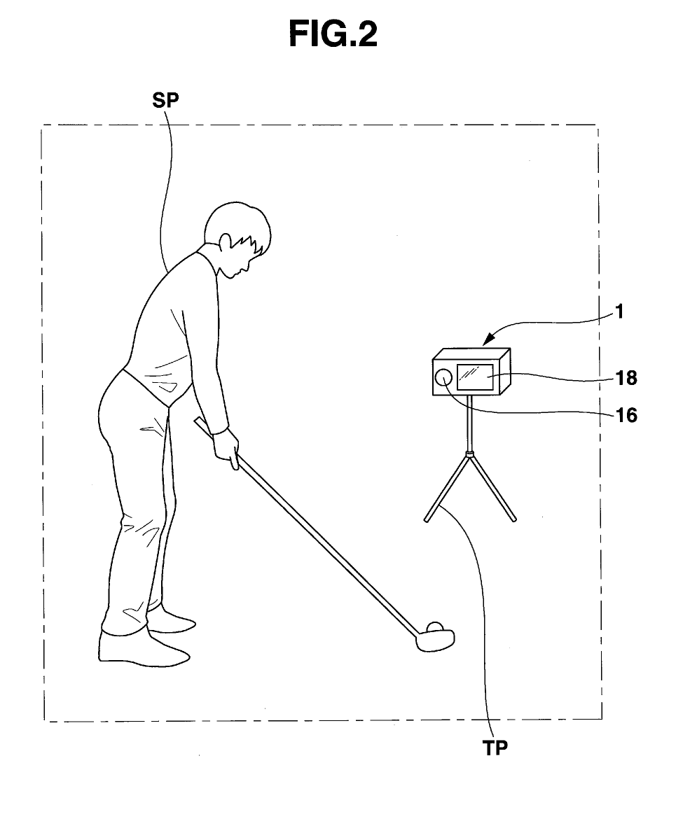

As shown in FIG. 2, the direction of an image sensor of the image capture unit 16 and the direction of the display surface of the output unit 18 in the image capture apparatus 1 are arranged so as to face a person swinging a golf club (hereinafter, referred to as “swing player SP”). In other words, the image capture apparatus 1 can capture the swing player SP and is arranged so that the display surface can be viewed by the swing player SP. In a state of such an arrangement, the image capture apparatus 1 photographs the swing player SP and displays an image on the output unit 18 so that the swing player SP can view the image.

It should be noted that, in the present embodiment, the image capture apparatus 1 photographs the entire swing of the swing player SP and is fixed by a tripod stand TP so that the image can be easily viewed by the swing player SP.

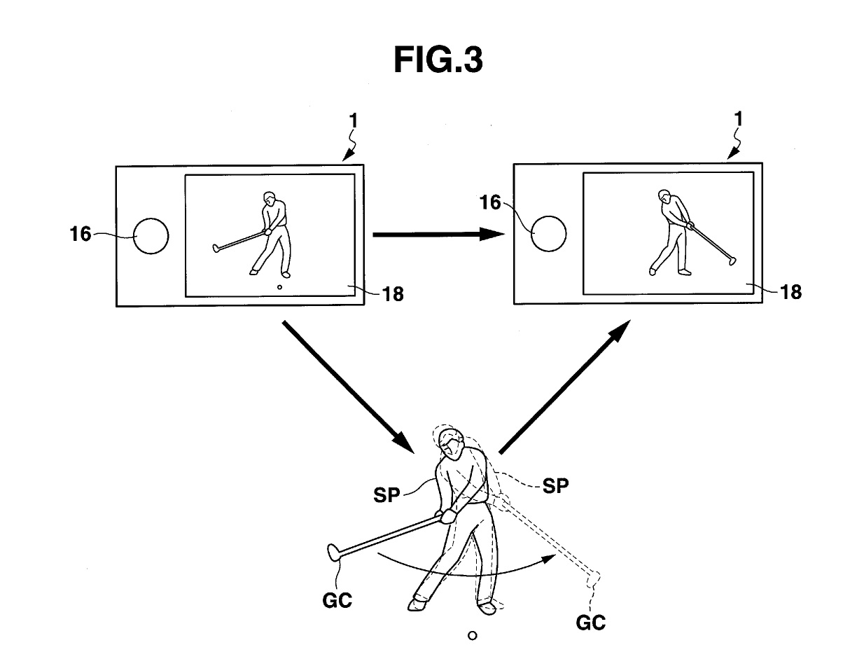

FIG. 3 is a schematic diagram showing a general outline of a display on the output unit 18.

The image capture apparatus 1 of the present embodiment initially stores a sequence of swing motions by the swing player SP as a moving image and then plays back the moving image stored according to an instruction from the swing player.

When playing back the moving image in the image capture apparatus 1, as shown in FIG. 3, during playback or stopping the moving image stored, the swing player SP as the subject swings a golf club GC from a predetermined position and then poses at a desired swing position (predetermined swing motion). The image capture apparatus 1 is thereby configured such that the moving image is fast-forwarded or fast-rewound to perform cueing the moving image in order to display the same swing motion as the predetermined swing motion thus posed and start playing back the moving image.

It should be noted that in the present embodiment, although the image is cued upon playing back, it may be configured so as to continuously display the image corresponding to the posing as a still image so long as a user does not release the posing. In such a case, if the user causes the swing posing to change, a still image corresponding to the posing changed is newly displayed.

The example of FIG. 3 shows that, when the swing player SP poses at a “follow” position while playing back the moving image stored, the moving image is started to play back upon fast-forwarding and performing cueing the moving image to the “follow” position (hereinafter, referred to as “cueing and playback”).

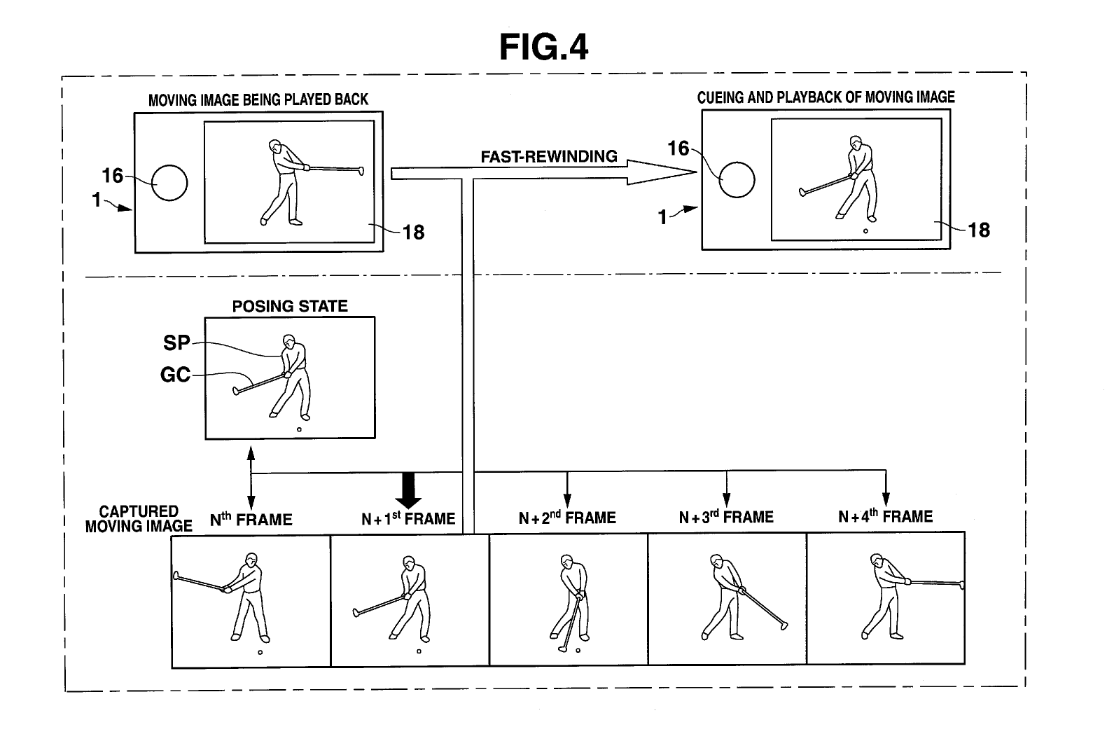

FIG. 4 is a schematic diagram showing a specific example of a method for cueing and playback.

As shown in FIG. 4, the image capture apparatus 1 analyzes the posing of the swing player SP while playing back the moving image so as to specify the swing motion. The analysis of the posture is performed, for example, by photographing the swing player SP as a subject by the image capture unit 16 and analyzing the image thus photographed or attaching a sensor (not shown) to the swing player SP or the golf club GC and analyzing information acquired from the sensor. It should be noted that a swing motion is specified at the seven points of “address”, “halfway back”, “top”, “halfway down”, “impact”, “follow”, and “finish”, in the order of a swing form in the present embodiment.

In this way, approximately the same swing motion as the swing motion specified from the posing of the swing player SP thus analyzed is searched from among each frame of the moving images being played back. Then, by starting to sequentially display from a frame as a result searched on the output unit 18, the cueing and playback is performed with the moving images being fast-forwarded or fast-rewound from the position of the moving image being played back. Therefore, the swing player SP views the moving image on which the cueing and playback is performed from a desired position that is designated by posing. In this way, since the swing player SP, for example, can check their own actual swing by referencing the moving image, it is possible to fix the person's own swing efficiently. Furthermore, since the swing player SP can check their own swing, it is possible to fix their own swing without needing another's help.

Furthermore, for example, with a two-screen configuration in which the swing player SP can view the moving image in which a swing is photographed and a current swing live view image, it is possible to fix a current swing from an objective perspective while checking positions in the moving image based on a desired swing motion.

In the example of FIG. 4, in a state in which the moving image that is currently played back is played back up to the “follow” position, when the swing player SP poses at the “back” position, it is shown that each frame of the moving images while being played back is searched, and the cueing and playback is performed by fast-rewinding the moving image up to the frame of the “back” position (the n+1^{th} frame) prior to the frame of the “follow” position that is being currently played back (n+4^{th} frame).

Therefore, in the image capture apparatus 1, the moving image during playback is searched based on the posing by the swing player SP, and thus it is possible to perform the cueing and playback from the position that matches the position of the posing.

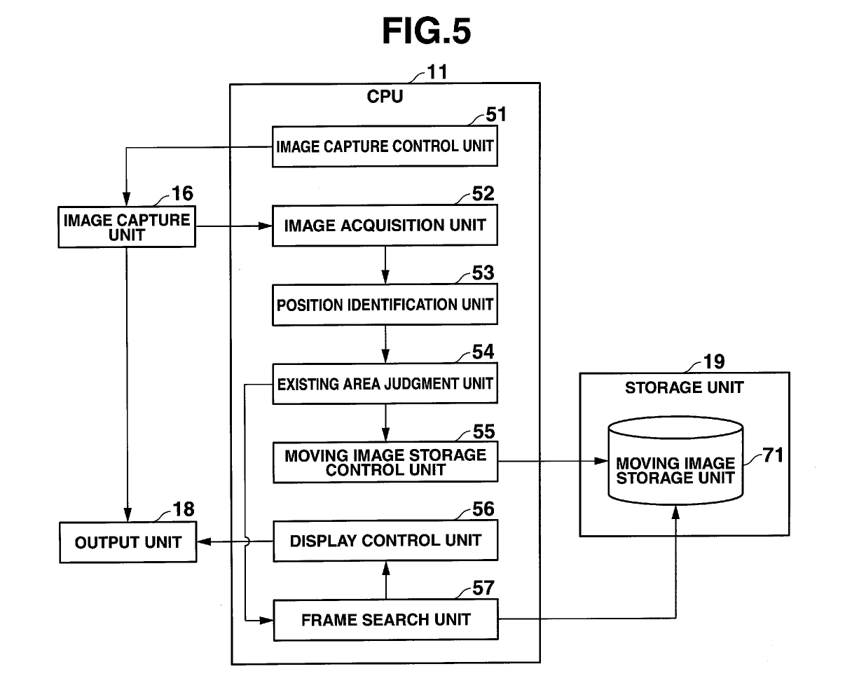

FIG. 5 is a functional block diagram showing a functional configuration for executing cueing and playback processing among the functional configurations of such an image capture apparatus 1. It should be noted that, in the image capture apparatus 1 of the present embodiment, various modes can be set and include a normal photographing mode for simple photography, a cueing and playback processing mode, and the like. The cueing and playback processing mode further includes a moving image photographing mode for photographing a moving image and a moving image playback mode for playing back the moving image photographed. The moving image photographing mode is a mode that captures a moving image for playing back. The moving image playback mode is a mode for playing back an image such as a moving image photographed by the moving image photographing mode and also a mode for performing the cueing and playback according to a posing of the swing player SP.

When executing the cueing and playback processing, as shown in FIG. 5, the image capture control unit 51, the image acquisition unit 52, a position identification unit 53, an existing area judgment unit 54, a moving image storage control unit 55, a display control unit 56, and a frame search unit 57 function in the CPU 11.

A moving image storage unit 71 is provided in an area of the storage unit 19.

In the moving image storage unit 71, data of the moving image composed of a plurality of frames outputted at the image capture unit 16 is stored to associate each frame with a swing motion. Furthermore, in the moving image in which a professional golfer is swinging, each frame is stored to be associated with the swing motion in the moving image storage unit 71.

The image capture control unit 51 controls the image capture unit 16 so as to perform photographing such as live view photographing.

The image acquisition unit 52 acquires a live view image outputted from the image capture unit 16 as frames composing a moving image.

The position identification unit 53 analyzes the frames acquired by the image acquisition unit 52 and identifies a position of a golf club in the frames. In order to identify the position of the club, the shaft of the club is extracted from each frame and the angle of the club is calculated based on the orientation of the shaft of the club thus extracted, for example. Well known technologies such as identifying the position of the golf club based on the angle of the golf club and the change of the angle between the frames are employed as well.

The existing area judgment unit 54 judges whether a golf club exists in various instruction areas (a swing area, a mode switch area, a photographing start area) formed by dividing the live view image displayed on the output unit 18 into a predetermined ranges. Here, an “instruction area” refers to an area that is set so as to perform a predetermined instruction when a club head imaged in a live view image comes into the instruction areas.

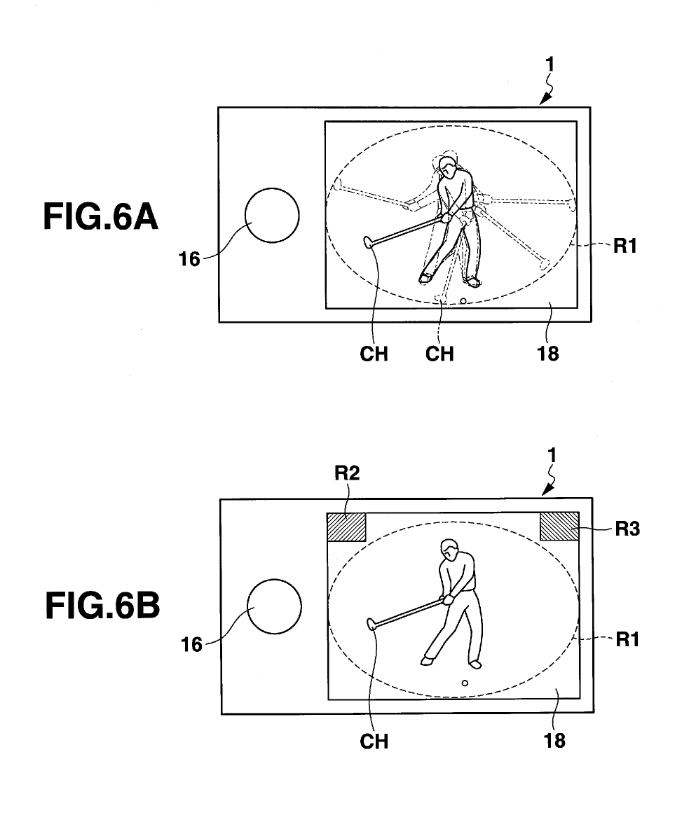

FIGS. 6A and 6B are schematic views for explaining an instruction area.

A swing area R1, as shown in FIG. 6A, refers to an area of a maximum range of a swing (a golf club head CH) by a swing player SP when photographing with the swing player SP being arranged at the center of the photographing area. It is possible to identify a swing motion of the swing player SP depending on where the golf club head is positioned in the swing area R1.

A mode switch area R2 refers to a predetermined area set outside the swing area R1 as shown in FIG. 6B. The mode switch area R2 refers to an area for switching between the moving image photographing mode and the moving image playback mode. In other words, it is possible to switch between the moving image photographing mode and the moving image playback mode by positioning the golf club head CH in the mode switch area.

In the present embodiment, the mode switch area R2 is established at the upper left corner of the output unit 18 in a rectangular shape. Therefore, when designating the mode switch area R2, the swing player SP extends the hand having the golf club beyond a normal swing area so as to position the golf club head CH on the mode switch area R2 on the output unit 18.

A photographing start area R3 is, as shown in FIG. 6B, established outside the swing area R1 and established at the upper right corner of the output unit 18 in a rectangular shape.

The photographing start area R3 and the mode switch area R2 are paired. The photographing start area R3 starts photographing a moving image, i.e. an area in which an instruction is done to start storing an image acquired from the image capture unit 16 as a moving image.

Furthermore, when designating the photographing start area R3, similarly to the mode switch area R2, the swing player SP extends the hand having the golf club beyond a normal swing area so as to position the golf club head CH on the mode switch area R3 on the output unit 18.

The moving image storage control unit 55 stores and saves each image outputted from the image capture unit 16 as a moving image in the moving image storage unit 71. In such a case, the moving image storage control unit 55 stores a sequence of swing motions (each of seven swing motions from “address” to “finish”) to be associated with each frame of the moving image.

The display control unit 56 starts playing back the moving image stored in the moving image storage unit 71 by displaying it on the output unit 18. Furthermore, the display control unit 56 starts the cueing and playback by fast-forwarding or fast-rewinding the moving image with a frame searched by the frame search unit 57 as a playback start frame.

The frame search unit 57 searches a frame corresponding to a position of a golf club in the moving image during playback. In other words, the frame search unit 57 identifies a swing state based on the position of the golf club within the swing area and searches for a frame corresponding to the swing state.

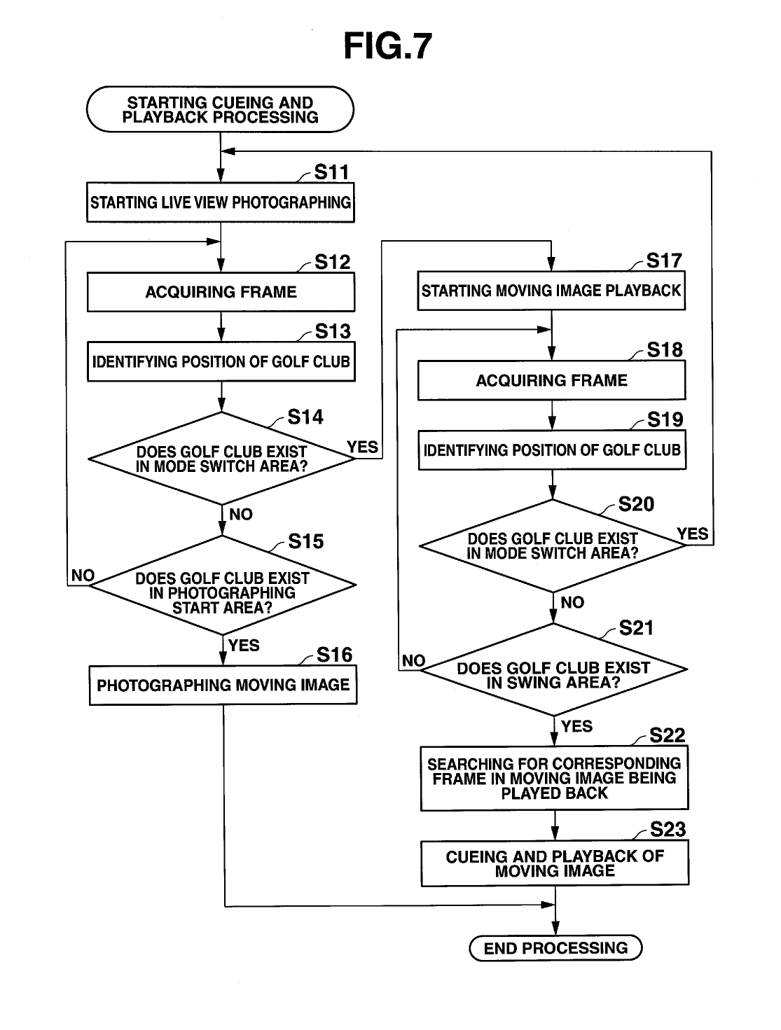

FIG. 7 is a flowchart explaining a flow of cueing and playback processing executed by the image capture apparatus 1 of FIG. 1 having the functional configuration of FIG. 5.

The “cueing and playback processing” refers to a sequence of processing of photographing a moving image for playback and playing back the moving image by fast-forwarding and fast-rewinding to a position corresponding to a posture of a subject (posing a predetermined swing motion by the swing player SP).

In Step S11, the image capture control unit 51 starts live view photographing. In other words, the image capture control unit 51 controls the image capture unit 16 so as to perform the live view photographing. As a result thereof, the display control unit 56 controls the output unit 18 to display a live view image acquired from the image capture unit 16.

In Step S12, the image acquisition unit 52 acquires the live view image outputted from the image capture unit 16 as frames constituting a moving image.

In Step S13, the position identification unit 53 analyzes the frames acquired by the image acquisition unit 52 to identify a position of a golf club in the frames.

In Step S14, the existing area judgment unit 54 judges whether the golf club exists in a mode switch area.

In a case in which the golf club exists in the mode switch area, it is judged as YES in Step S14 and the processing advances to Step S17. The processing of Step S17 and higher is described later.

On the other hand, in a case in which the golf club does not exist in the mode switch area, it is judged as NO in Step S14 and the processing advances to Step S15.

In Step S15, the existing area judgment unit 54 judges whether the golf club exists in a photographing start area.

In a case in which the golf club does not exist in the photographing start area, it is judged as NO in Step S15 and the processing advances to Step S12. Then, the processing of Steps S12 and higher is performed.

On the other hand, in a case in which the golf club exists in the photographing start area, it is judged as YES in Step S15 and the processing advances to Step S16.

In Step S16, the moving image storage control unit 55 stores to save an image outputted from the image capture unit 16 as a moving image in the moving image storage unit 71. On this occasion, the moving image storage control unit 55 stores to save swing motions (seven swing motions from “address” to “finish”) to be associated with each frame of the moving image. Subsequently, the cueing and playback processing ends.

In Step S17, the display control unit 56 starts playing back by displaying the moving image stored in the moving image storage unit 71 on the output unit 18. On this occasion, the output unit 18 displays the moving image in place of the live view image.

In Step S18, the image acquisition unit 52 acquires the live view image outputted from the image capture unit 16 as a frame image.

In Step S19, the position identification unit 53 analyzes the frame image acquired by the image acquisition unit 52 and identifies the position of the golf club in the frame image.

In Step S20, the existing area judgment unit 54 judges whether the golf club exists in the mode switch area.

In a case in which the golf club exists in the mode switch area, it is judged as YES in Step S20 and the processing advances to Step S11. Subsequently, the processing of Steps S11 and higher is performed.

On the other hand, in a case in which the golf club does not exist in the mode switch area, it is judged as NO in Step S20 and the processing advances to Step S21.

In Step S21, the existing area judgment unit 54 judges whether the golf club exists in the swing area.

In a case in which the golf club does not exist in the swing area, it is judged as NO in Step S21 and the processing advances to Step S18. Subsequently, the processing of Steps S18 and higher is performed.

On the other hand, in a case in which the golf club exists in the swing area, it is judged as YES in Step S21, and the processing advances to Step S22.

In Step S22, the frame search unit 57 searches for a frame corresponding to the position of the golf club in the moving image during playback. In other words, the frame search unit 57 identifies a swing state based on the position of the golf club in the swing area and searches for a frame corresponding to the swing state. More specifically, for example, as shown in FIG. 3, in a case in which the posing of the swing player SP corresponds to “follow” in the swing area, a frame of the swing motion of “follow” that is associated with each frame of the moving image stored is searched.

In Step S23, the display control unit 56 starts the cueing and playback by fast-forwarding or fast-rewinding the moving image with the frame searched by the frame search unit 57 being a playback start frame. Subsequently, the cueing and playback processing ends.

### Second Embodiment

It is configured in the first embodiment to start performing the cueing and playback from a frame corresponding to the swing motion of the swing player SP.

On the other hand, it is configured in the second embodiment so as to display a moving image to match with a timing of a swing of the swing player SP. In other words, it is configured in the second embodiment to perform playback of a moving image that interlocks with the swing of the swing player SP.

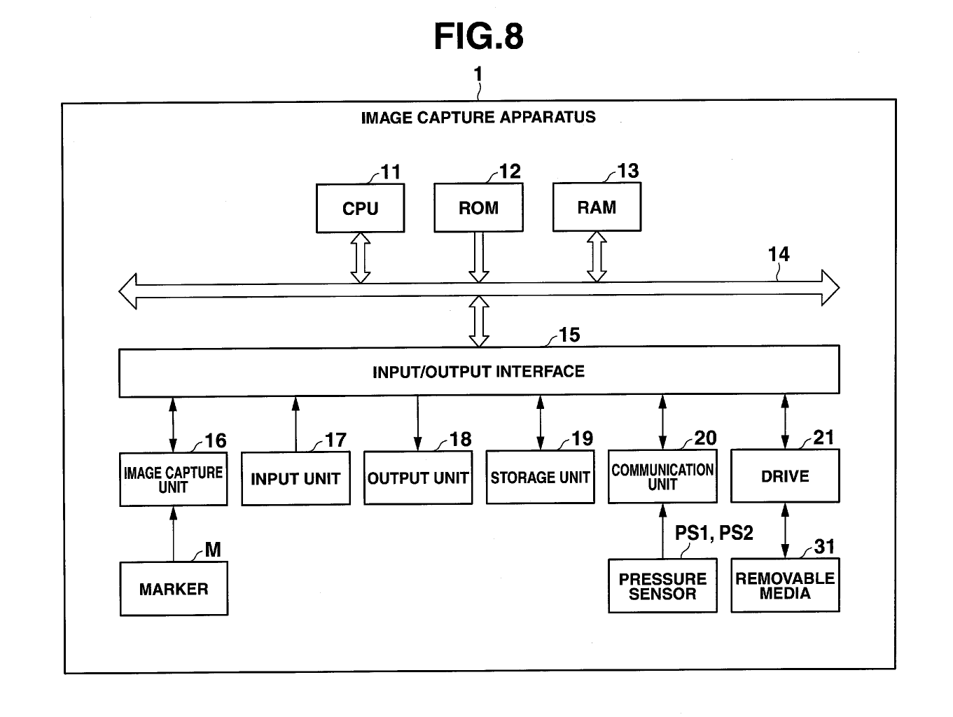

FIG. 8 is a block diagram showing a hardware configuration of an image capture apparatus according to the second embodiment of the present invention.

When comparing between FIG. 1 and FIG. 8, since the hardware configuration of the image capture apparatus 1 according to the second embodiment is basically the same as that according to the first embodiment except for a marker M and pressure sensors PS1 and PS2 being added, the descriptions therefor are omitted.

It should be noted that the marker M is configured so that the location thereof can be identified by capturing the image by the image capture unit 16 and is composed of a reflective material, etc.

Furthermore, the pressure sensors PS1 and PS2 are configured so as to calculate atmospheric pressure and detect change in the atmospheric pressure.

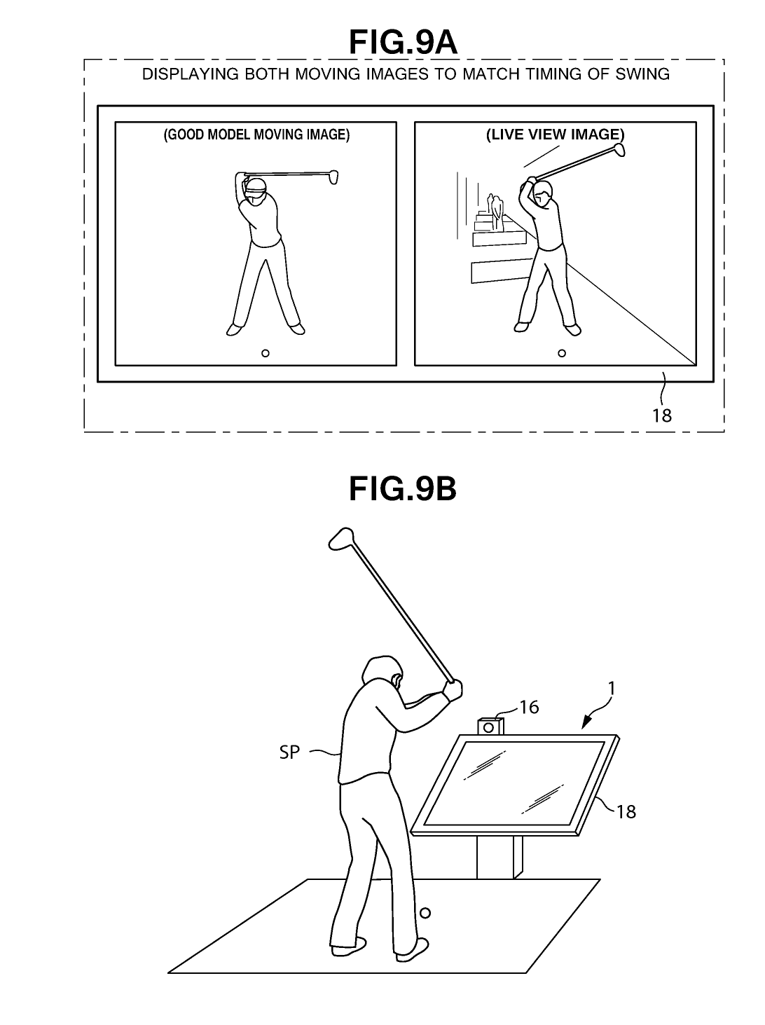

FIGS. 9A and 9B are schematic diagrams showing an outline of a utilization form of the image capture apparatus 1 having such a hardware configuration.

As shown in FIG. 9A, the image capture apparatus 1 displays on two screens of the output unit 18 a live view image in which a swing player SP is captured and a moving image displaying that is linked to the live view image in a parallel manner. Furthermore, in the moving image that is displayed to interlock with the live view image, a moving image of the swing of a professional golfer as a good model for a swing is played back (hereinafter, referred to “good model moving image”).

The image capture apparatus 1 having such a function is configured such that it is easily viewable by the swing player SP checking the display and easily able to photograph the swing player SP. More specifically, as shown in FIG. 9B, the image capture apparatus 1 includes: an output unit 18 that is configured with a large-size display of which the height and angle are adjusted so as to be easily viewed by a swing player SP; and the image capture unit 16 that is provided at an upper portion of the output unit 18 so that the image capture unit 16 can photograph an entire swing by the swing player SP. It should be noted that, although the present embodiment includes the image capture unit 16 and the output unit 18 in the image capture apparatus 1 as an image capture means and an output means, the present invention is not limited thereto. For example, it may be configured so as to establish the image capture means and the output means as separate devices so as to exchange a captured image and a moving image through communication, and integrally operate photographing and outputting.

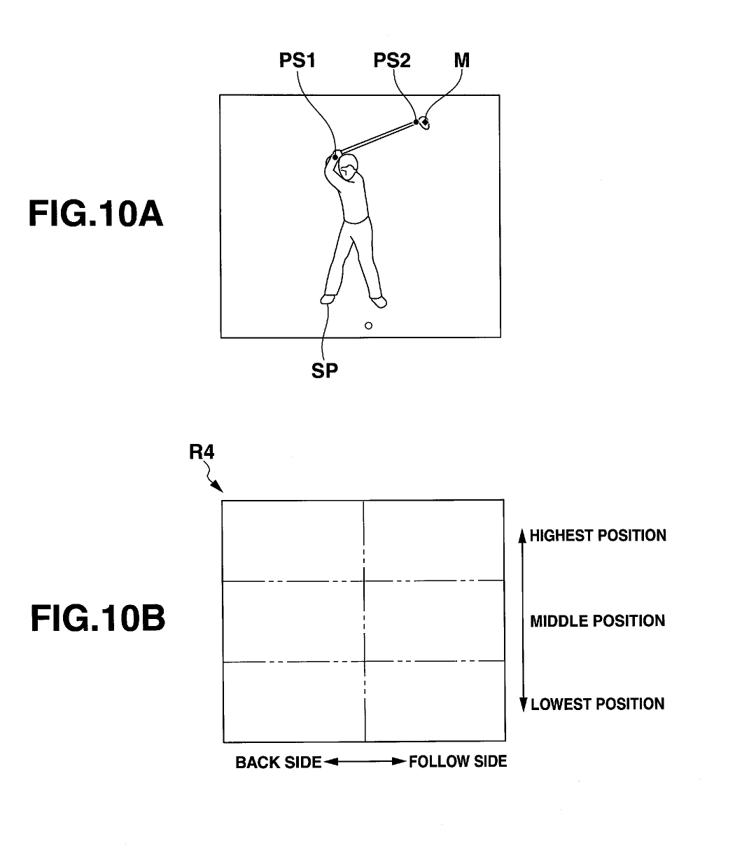

FIG. 10 is a schematic diagram illustrating identification of a swing.

As shown in FIG. 10A, the identification of a swing is performed by identifying a relative position in a photographing area of the marker M by way of analyzing an image in which the swing player SP is photographed with the marker M being attached to the golf club head CH. In the present embodiment, identification is performed as to whether it is a “back” side (left side if a right-handed person) or a “follow” side (right side if a right-handed person) of a swing in the photographing area with the position of “address” being at the center, based on the relative position of the marker M thus identified.

Furthermore, in the present embodiment, the pressure sensors PS1 and PS2 are provided respectively at an end portion of a golf club shaft CS and an arm of the swing player SP. By providing the pressure sensors PS1 and PS2 at such locations, it is possible to acquire information regarding how high the golf club is positioned, for example, from each pressure sensor. Furthermore, it is possible to identify a moving direction based on a difference from a previous measured position.

With the abovementioned configuration, positions of the back side/follow side and how high the golf club is positioned are identified based on the information acquired from the marker M and the pressure sensors PS1 and PS2 and a swing motion by the swing player SP is identified based on the moving direction of the golf club.

Furthermore, in order to identify the swing motion in the present embodiment, as shown in FIG. 10B, a swing judgment area R4 is established which is formed by dividing the photographing area in which the swing is performed into six areas. In this swing judgment area R4, each of the back side and the follow side is divided into the three stages of the highest position, a middle position, and the lowest position.

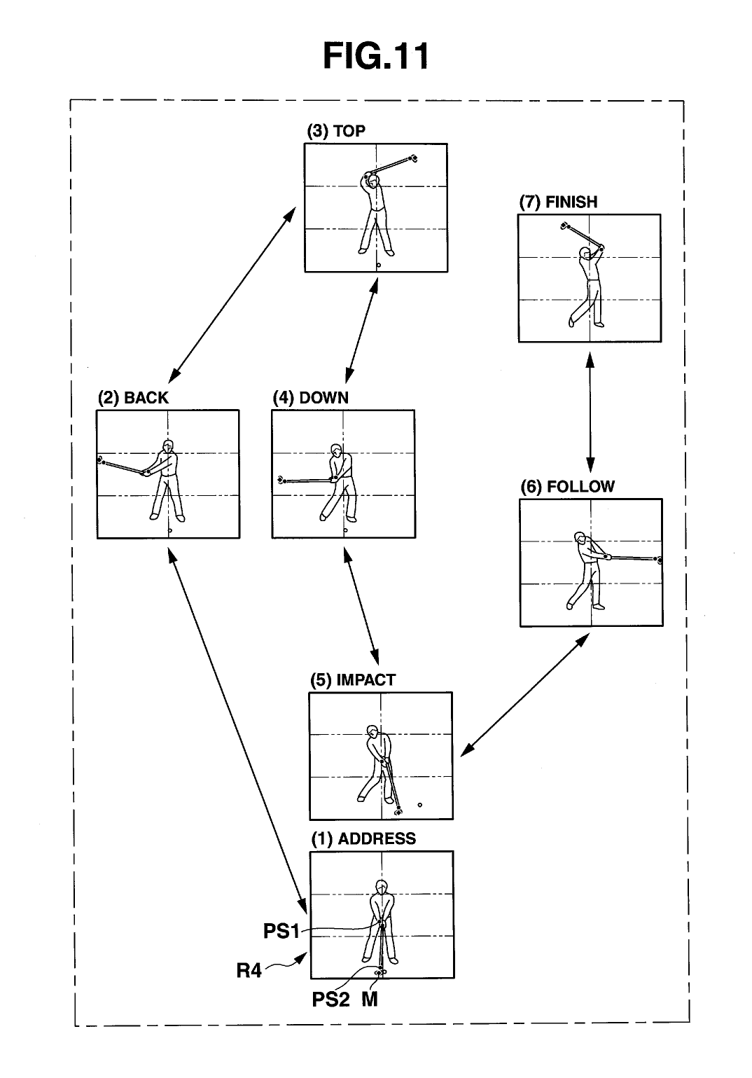

FIG. 11 is a schematic diagram illustrating specific details of a swing motion.

More specifically, as shown in FIG. 11, in order to identify the swing motion, the photographing area is divided into six areas, which is the swing judgment area R4, according to the transition of the swing as described above and, in the range of the swing transition drawn as an arc, the six areas are further divided into the back side and the follow side, each of which has three areas (the highest position, the middle position, and the lowest position). The identification of the swing motion is performed in the swing judgment area R4 in this way.

The swing judgment area R4 is divided into: a “back side/lowest position” identifying “address”; a “back side/middle position” identifying “back” and “down”; a “back side/highest position” identifying “top”; a “follow side/lowest position” identifying “impact”; a “follow side/middle position” identifying “follow”; and a “follow side/highest position” identifying “finish”, in the sequential order of swing motion.

The judgment for identifying the swing motion is performed by considering which area in the swing judgment area R4 the swing motion belongs to, as well as considering whether having transitioned from a previous state, i.e. from one state to another state based on the information of the pressure sensors. More specifically, the judgment for identifying the swing motion is described in the sequential order of the swing motion as follows:

(1) In the case of “address”, “previous state: none, PS1: lowest position, PS2: lowest position”.

(2) In the case of “back”, “previous state: address, PS1: change from lowest position to middle position, PS2: change from lowest position to middle position; marker: back side”.

(3) In the case of “top”, “previous state: back, PS1: highest position, PS2: highest position”.

(4) In the case of “down”, “previous state: top, PS1: change from highest position to middle position, PS2: change from highest position to middle position, marker: back side”.

(5) In the case of “impact”, “previous state: down, PS1: lowest position, PS2: lowest position”.

(6) In the case of “follow”, “previous state: impact, PS1: change from lowest position to middle position, PS2: change from lowest position to middle position, marker: follow side”.

(7) In the case of “finish”, “previous state: follow, PS1: highest position, PS2: highest position”.

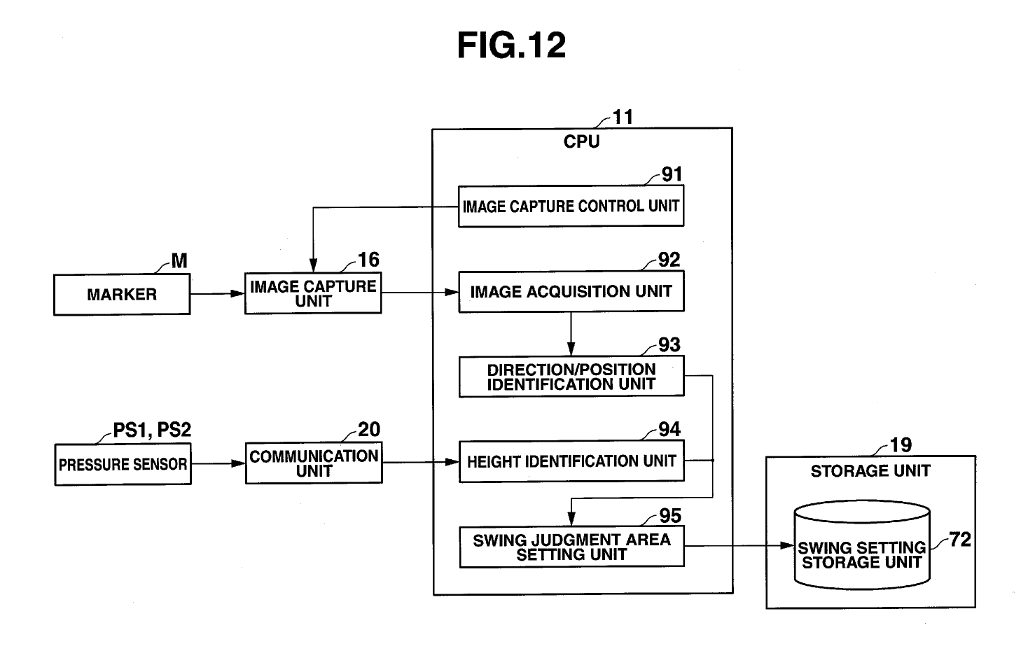

FIG. 12 is a functional block diagram showing a functional configuration for executing swing setting processing of interlock display mode processing among the functional configurations of such an image capture apparatus 1.

The “interlock display mode processing” is processing of a mode aside from a normal photographing mode and refers to a sequence of processing of performing displaying on the output unit 18 so as to interlock with a motion of a subject. Furthermore, the “interlock display mode processing” includes the swing setting processing and interlock display processing.

The “swing setting processing” refers to a sequence of processing of acquiring positional information of a golf club from a sequence of a swing motion identified by the sensors and the marker until determining a swing area. It is possible to identify a swing state based on the position of the golf club in the swing area thus determined.

When executing the swing setting processing, as shown in FIG. 12, an image capture control unit 91, an image acquisition unit 92, a direction/position identification unit 93, a height identification unit 94, and a swing judgment area setting unit 95 function in the CPU 11.

A swing setting storage unit 72 is provided in an area of the storage unit 19.

In the swing setting storage unit 72, information relating to a swing judgment area set in the swing setting processing is stored.

The image capture control unit 91 starts live view photographing. In other words, the image capture control unit 51 controls the image capture unit 16 so as to perform the live view photographing.

The image acquisition unit 92 acquires a live view image outputted from the image capture unit 16 as an image for analyzing a marker's position (hereinafter, referred to as “image for analysis”).

The direction/position identification unit 93 analyzes the image for analysis thus acquired to identify the marker's position in the image. For example, as shown in FIG. 11, based on the marker's position, it is possible to identify the position on the back side (the positions from “address” to “impact” of the golf club GC) and the position on the follow side (the positions from “impact” to “finish” of the golf club GC).

The height identification unit 94 acquires information from the pressure sensors (pressure sensors PS1 and PS2) via the communication unit 20 and, as shown in FIG. 11, for example, identifies how high the golf club is positioned based on the positions of the pressure sensors PS1 and PS2.

The swing judgment area setting unit 95 determines the swing judgment area R4 as shown in FIG. 10B corresponding to the swing motion area of the swing player SP based on the scope of the swing of the golf club in a sequence of the swing motion identified by the direction/position identification unit 93 and the height identification unit 94.

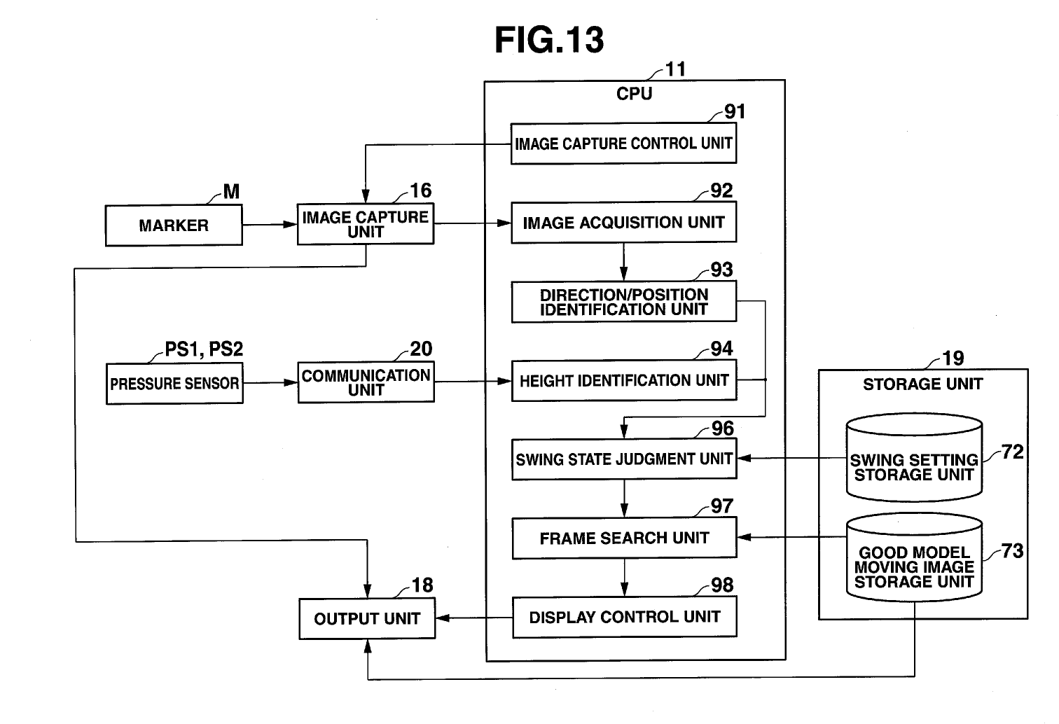

FIG. 13 is a functional block diagram showing a functional configuration for executing interlock display processing of the interlock display mode processing among the functional configurations of the image capture apparatus 1 of FIG. 8.

The “interlock display processing” refers to a sequence of processing of displaying an image corresponding to a swing motion to be stored according to a swing of a subject. Furthermore, the “interlock display processing” simultaneously displays a live view image in addition to an image corresponding to a swing motion.

When executing the interlock display processing, as shown in FIG. 13, the image capture unit 91, the image acquisition unit 92, a direction/position identification unit 93, a height identification unit 94, a swing state judgment unit 96, a frame search unit 97, and a display control unit 98 function in the CPU 11.

The swing setting storage unit 72 and a good model moving image storage unit 73 are provided in an area of the storage unit 19.

In the good model moving image storage unit 73, data of the good model moving image in which the swing of a professional golfer is stored. This good model moving image is stored to be associated with a swing motion for each frame.

The swing state judgment unit 96 judges a swing state.

The judgment of the swing state is performed by judging which area of the swing areas determined in the swing setting processing the golf club is positioned.

More specifically, the swing state judgment unit 96 judges as follows: “address” in a case of judging that the golf club belongs to “back side/lowest position”; “back” or “down” in a case of judging that the golf club belongs to “back side/middle position”; “top” in a case of judging that the golf club belongs to “back side/highest position”; “impact” in a case of judging that the golf club belongs to “follow side/lowest position”; “follow” in a case of judging that the golf club belongs to “follow side/middle position”; and “finish” in a case of judging that the golf club belongs to “follow side/highest position”. In such cases, the judgment of a state of each swing motion is performed by considering whether having transitioned from a previous state, i.e. from one state to another state based on the information of the pressure sensors. For example, regarding the judgment of whether it is “back” or “down”, if it is “back side/middle position”, it is possible to judge whether it is “back” or “down” based on the previous state thereto, for example, whether it is “address” or “top”. If the previous state is “address”, then it is judged as “back”, and if the previous state is “top”, then it is judged as “down”.

The frame search unit 97 searches the good model moving image stored in the good model moving image storage unit 73 and identifies a frame corresponding to the swing state thus determined.

Furthermore, the frame search unit 97 judges whether there is a good model image beforehand. In other words, the frame search unit 97 judges whether there still remains a frame performing interlock display in the good model moving image stored in the good model moving image storage unit 73.

The display control unit 98 performs interlock display. More specifically, the display control unit 98 displays a good model image searched by the frame search unit 97, on the output unit 18. Furthermore, the display control unit 98 performs two-screen display by displaying the live view image as well as the good model image in a parallel manner. As a result thereof, frames from “address” to “finish” extracted from the good model moving image are displayed to correspond to the live view image photographing a swing of the swing player SP. It should be noted that, although seven positions including “address” to “finish” identify a swing motion in the present embodiment, the present invention is not limited thereto. It is possible to provide frames that suit the live view image by identifying a swing motion at more detailed points, and thus it is possible to perform displaying smoothly as if displaying a moving image.

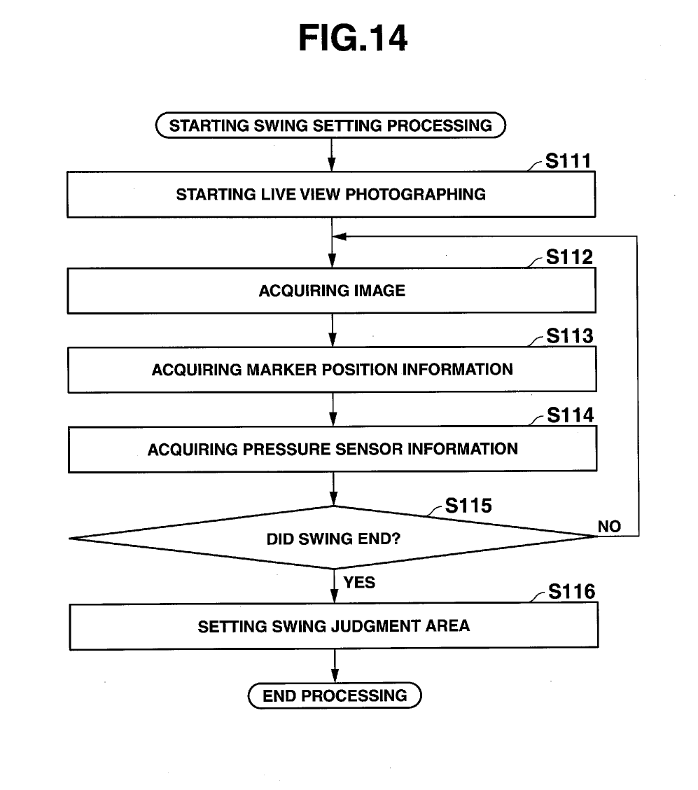

FIG. 14 is a flowchart showing a flow of swing setting processing among the interlock display mode processing.

In Step S111, the image capture control unit 91 starts live view photographing. In other words, the image capture control unit 51 controls the image capture unit 16 so as to perform the live view photographing.

As a result thereof, the live view image acquired from the image capture unit 16 is displayed on the output unit 18.

In Step S112, the image acquisition unit 92 acquires the live view image outputted from the image capture unit 16 as an image for analysis.

In Step S113, the direction/position identification unit 93 analyzes the image for analysis thus acquired and identifies the position of the marker in the image. It is possible to identify the position of the golf club from “address” to “impact” (position on the back side) and the position of the golf club from “impact” to “finish” (position on the follow side) based on the position of the marker.

In Step S114, the height identification unit 94 acquires information from the pressure sensors (pressure sensors PS1 and PS2) via the communication unit 20 and identifies how high the golf club is positioned based on the positions of the pressure sensors PS1 and PS2.

In Step S115, the swing judgment area setting unit 95 judges whether the swing has ended. The end of the swing is judged based on, for example, the event of a state of a golf club does not changing for a predetermined period of time or the event of a position of the golf club being on the follow side and moving up to a predetermined height.

If the swing has not ended, it is judged as NO in Step S115 and the processing advances to Step S112. Then, the processing of Steps S112 and higher is performed.

On the other hand, in a case in which the swing ended, it is judged as YES in Step S115 and the processing advances to Step S116.

In Step S116, the swing judgment area setting unit 95 establishes a swing judgment area. In other words, the swing judgment area setting unit 95 establishes a swing judgment area R4 as shown in FIG. 10B in consideration of the scope of the swing of the golf club by the swing player SP. Then, the swing judgment area setting unit 95 stores the swing judgment area in the swing setting storage unit 72. Subsequently, the swing setting processing ends.

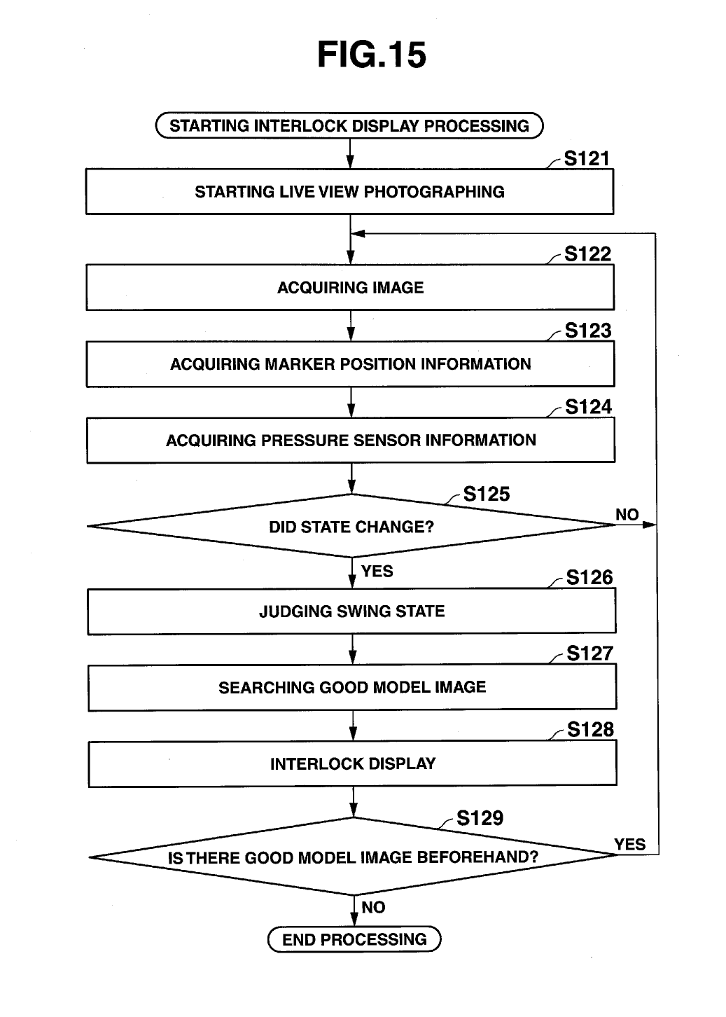

FIG. 15 is a flowchart showing a flow of the interlock display processing in the interlock display mode processing.

In Step S121, the image capture unit 91 starts the live view photographing. In other words, the image capture control unit 51 controls the image capture unit 16 so as to perform the live view photographing.

As a result thereof, the live view image acquired from the image capture unit 16 is displayed.

In Step S122, the image acquisition unit 92 captures and acquires the live view image outputted from the image capture unit 16 as an image for analysis.

In Step S123, the direction/position identification unit 93 analyzes the image for analysis thus acquired and identifies a position of a marker in the image.

In Step S124, the height identification unit 94 acquires information from the pressure sensors via the communication unit 20 and identifies how high the golf club is positioned based on the positions of the pressure sensors PS1 and PS2.

In Step S125, the swing state judgment unit 96 judges whether the swing state has changed. In other words, the swing state judgment unit 96 judges whether the height and direction of the golf club have changed.

In a case in which the height and direction of the golf club have not changed, it is judged as NO in Step S125 and the processing advances to Step S122. Then, the processing of Steps S122 and higher is performed.

On the other hand, in a case in which the height and direction of the golf club have changed, it is judged as YES in Step S125 and the processing advances to Step S126.

In Step S126, the swing state judgment unit 96 performs judgment of the swing state.

The judgment of the swing state is performed by judging in which area of the swing judgment areas determined in the swing setting processing a golf club is positioned. More specifically, the swing state judgment unit 96 judges which pattern a swing state belongs to from among the patterns of (1) to (7) shown in FIG. 11.

In Step S127, the frame search unit 97 searches the good model moving image stored in the good model moving image storage unit 73 and identifies a frame corresponding to the swing state thus judged.

In Step S127, the display control unit 98 performs interlock display. More specifically, the display control unit 98 displays a frame of the good model image searched by the frame search unit 97 on the output unit 18. Furthermore, the display control unit 98 performs two-screen display by displaying the live view image as well as a frame of the good model image in a parallel manner.

In Step S128, the frame search unit 97 judges whether there is a good model image beforehand. In other words, the frame search unit 97 judges whether there still remains a frame performing interlock display (a frame corresponding to a swing motion) in the good model moving image stored in the good model moving image storage unit 73. For example, in a case in which the interlock display frame is a frame of the good model of “back” and there is a frame corresponding to the good model image of “top” and subsequent images, the frame search unit 97 judges that there is a good model image. On the other hand, in a case in which the interlock display frame is a frame of the good model of “finish” and there is not a good model image, the frame search unit 97 judges that there is not a good model image.

In a case in which there is a good model image in advance, it is judged as YES in Step S128 and the processing advances to S122. Subsequently, the processing of Steps S122 and higher is performed.

In a case in which there is not a good model image, it is judged as NO in Step S128, and the interlock display processing ends.

The image capture apparatus 1 configured as described above includes the frame search unit 97, the swing state judgment unit 96, and the display control unit 98.

The swing state judgment unit 96 identifies a plurality of postures in a motion of the swing player SP.

The frame search unit 97 searches for an image corresponding to a predetermined posture identified by the swing state judgment unit 96 from a moving image as a search target.

The display control unit 98 displays an image searched and found by the frame search unit 97 on the output unit 18.

In this way, in the image capture apparatus 1, an image corresponding to a predetermined position identified and the image thus searched and found is displayed on the output unit 18.

Therefore, in the image capture apparatus 1, it is possible to display information corresponding to a motion of a user at an effective timing.

The image capture apparatus 1 further includes the good model moving image storage unit 73 that stores a moving image.

The frame search unit 97 searches an image corresponding to a predetermined posture (swing motion) identified by the swing state judgment unit 96 from the good model moving image stored in the good model moving image storage unit 73.

Furthermore, the frame search unit 97 acquires the image thus searched and found as an image corresponding to a predetermined posture (swing motion).

In this way, in the image capture apparatus 1, the image corresponding to the predetermined posture (swing motion) is searched from the good model moving image stored in the good model moving image storage unit 73 and is acquired as the image corresponding to the predetermined posture (swing motion).

Therefore, in the image capture apparatus 1, it is possible to display information corresponding to a user motion at an effective timing.

The image capture apparatus 1 further includes the image acquisition unit 92 that sequentially acquires captured images that are continuously captured.

The swing state judgment unit 96 identifies a predetermined posture (swing motion) from the images that are sequentially acquired by the image acquisition unit 92.

In this way, with the image capture apparatus 1, the predetermined posture (swing motion) is identified from the captured images that are continuously captured.

Therefore, with the image capture apparatus 1, it is possible to set the captured images as an identification target, a result of which it can be used in various ways.

Furthermore, the swing state judgment unit 96 identifies a specific position based on information from the pressure sensors PS1 and PS2 attached to the swing player SP or golf club.

Therefore, with the image capture apparatus 1, it is possible to identify the user's motion with high precision.

Furthermore, the moving image that is set as a search target by the frame search unit 97 is a moving image in which a motion as a good model for the motion of the swing player SP is stored.

Therefore, with the image capture apparatus 1, it is possible to display information that can be compared with the user's motion at an effective timing.

The image capture apparatus 1 further includes the image capture unit 16 that sequentially captures a specific target (swing player SP).

The frame search unit 97 identifies a predetermined posture (swing) of the specific target (swing player SP) in the images that are sequentially captured by the image capture unit 16.

The display control unit 98 simultaneously displays the image captured by the image capture unit 16 as well as the image acquired by the frame search unit 97 on the output unit 18.

Therefore, with the image capture apparatus 1, it is possible to easily compare with the user's motion.

Furthermore, the images that are sequentially captured by the image capture unit 16 are captured images that are captured in real time.

Therefore, in the image capture apparatus 1, it is possible to easily compare with the user's motion instantaneously.

It should be noted that the present invention is not to be limited to the aforementioned embodiment, and that modifications, improvements, etc. within a scope that can achieve the object of the present invention are also included in the present invention.

The type of the good model moving image as a search target in the abovementioned embodiment may be, for example, an actual moving image in which a real professional golfer performs a swing motion or may be an unrealistic moving image such as a moving image of the swing motion of a skeleton.

In the abovementioned embodiment, although it is configured to search for and display an image corresponding to an analysis result from a moving image, the present invention is not limited thereto.

It may be configured, for example, to play back a moving image of a subject stored beforehand, and then search for and display an image corresponding to the posing of the subject in the moving image thus played back from another moving image.

In this case, it may be configured so that a moving image as a search target and a moving image as an analysis target stored beforehand are respectively acquired and displayed on a predetermined display in a two-screen manner, and then, upon the user's operation of fast-forwarding or fast-rewinding on a moving image as an analysis target, the posing of the subject in the image displayed after the operation is analyzed and an image corresponding to an analysis result is searched for and displayed. In other words, upon the user's forwarding operation on a different moving image, the swing state judgment unit 96 identifies a predetermined posture in the image in the moving image after forwarding operation.

Furthermore, it may be configured so that, each time an operation such as fast-forwarding or fast-rewinding on the moving image as an analysis target is performed, the posing of the subject (swing player SP) in the image displayed after the operation is analyzed, with a point in time when a moving image as a search target and a moving image as an analysis target are displayed on the display in a two-screen manner being as a start time without a user's operation.

Furthermore, it may be configured so that, upon a moving image as a search target and a moving image as an analysis target being displayed on the display in a two-screen manner and these moving images being played back, an image in the moving image as a search target corresponding to a posing of the subject (swing player SP) in each image in the moving image as an analysis target is sequentially searched and synchronously played back on the display in a two-screen manner.

In other words, the display control unit 98 simultaneously displays, on the output unit 18, a moving image acquired by the frame search unit 97 and a moving image different from the moving image.

The swing state judgment unit 96 identifies a predetermined posture of a subject (swing player SP) in a moving image that is different from one that is displayed on the output unit 18 by the display control unit 98.

With such a configuration, it is possible to automatically display on the display an image in the moving image as a search target corresponding to an image in the moving image as an analysis target.

Furthermore, various well-known technologies can be employed for the identification of a swing motion of the swing player SP in the abovementioned embodiment.

Furthermore, although the explanation for the swing of a golf club are provided in the abovementioned embodiment, the present invention is not limited thereto, and any motion may be employed so long as it is a motion of a subject to identify motion. Furthermore, it is not necessary to employ a motion that is fixed, and thus it may be configured to store predetermined motions beforehand as analysis targets.

In the aforementioned embodiments, a digital camera has been described as an example of the image capture apparatus 1 to which the present invention is applied; however, the present invention is not particularly limited thereto.

For example, the present invention can be applied to any electronic device in general having an image processing function. More specifically, for example, the present invention can be applied to a lap-top personal computer, a printer, a television, a video camera, a portable navigation device, a cell phone device, a portable gaming device, and the like.

The processing sequence described above can be executed by hardware, and can also be executed by software.

In other words, the hardware configuration shown in FIGS. 5 and 13 is merely an illustrative example, and the present invention is not particularly limited thereto. More specifically, the types of functional blocks employed to realize the above-described functions are not particularly limited to the example shown in FIGS. 5 and 13, so long as the image capture apparatus 1 can be provided with the functions enabling the aforementioned processing sequence to be executed in its entirety.

A single functional block may be configured by a single piece of hardware, a single installation of software, or any combination thereof.

In a case in which the processing sequence is executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program can not only be constituted by the removable medium 31 shown in FIG. 1 distributed separately from the device main body for supplying the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), or the like. The magnetic optical disk is composed of an MD (Mini-Disk) or the like. The storage medium supplied to the user in a state incorporated in the device main body in advance may include, for example, the ROM 12 shown in FIG. 1, a hard disk included in the storage unit 19 shown in FIG. 1 or the like, in which the program is recorded.

It should be noted that, in the present specification, the steps describing the program recorded in the storage medium include not only the processing executed in a time series following this order, but also processing executed in parallel or individually, which is not necessarily executed in a time series.

Although some embodiments of the present invention have been described above, the embodiments are merely exemplification, and do not limit the technical scope of the present invention. Other various embodiments can be employed for the present invention, and various modifications such as omission and replacement are possible without departing from the spirits of the present invention. Such embodiments and modifications are included in the scope of the invention and the summary described in the present specification, and are included in the invention recited in the claims as well as the equivalent scope thereof.

1. A display control apparatus comprising:
a moving image acquisition unit that acquires a first moving image of a sequence of motions of a first subject;
an identification unit that identifies a current posture in a sequence of motions of a second subject;
an image acquisition unit that acquires, from the first moving image, an image corresponding to the current posture; and
a first display control unit that causes a display to display the acquired image acquired by the image acquisition unit.

2. The display control apparatus according to claim 1,
wherein the first display control unit causes the display to display, as a basis of a playback order of the first moving image, the acquired image.

3. The display control apparatus according to claim 1,
further comprising an image storage unit that stores the first moving image,
wherein the image acquisition unit further includes a search unit that searches for and finds an image corresponding to the current posture, from the first moving images stored in the image storage unit, and
the image acquisition unit acquires the image found by the search unit as the image corresponding to the current posture.

4. The display control apparatus according to claim 1,
further comprising a captured image acquisition unit that sequentially acquires images that are continuously captured,
wherein the identification unit identifies the current posture from the images that are sequentially acquired by the captured image acquisition unit.

5. The display control apparatus according to claim 1,
wherein the identification unit identifies the current posture based on information from a sensor that detects a motion of the second subject.

6. The display control apparatus according to claim 1,
further comprising a second display control unit that causes the display to simultaneously display the first moving image and a second moving image different from the first moving image,
wherein the identification unit identifies the current posture of the second subject in the second moving image.

7. The display control apparatus according to claim 5,
wherein, upon a user making a forwarding operation on the second moving image, the identification unit identifies the current posture in the image in the second moving image after the forwarding operation.

8. The display control apparatus according to claim 1,
wherein the first moving image is a moving image in which a motion of a good model for the motion of the second subject is captured.

9. The display control apparatus according to claim 1,
further comprising an image capture unit that sequentially captures the second subject,
wherein the identification unit identifies the current posture of the second subject in images that are sequentially captured by the image capture unit, and
the first display control unit causes the display unit to simultaneously display the image acquired by the image acquisition unit and the image captured by the image capture unit.

10. The display control apparatus according to claim 8,
wherein the images sequentially captured by the image capture unit are images that are captured in real time.

11. A display control method comprising:
acquiring a moving image of a sequence of motions of a first subject;
identifying a current posture in a sequence of motions of a second subject;
acquiring, from the moving image, an image corresponding to the current posture; and
causing a display to display the image acquired by the image acquisition unit.

12. A non-transitory storage medium encoded with a computer-readable program that enables a computer to execute functions as:
a moving image acquisition unit that acquires a moving image of a sequence of motions of a first subject;
an identification unit that identifies a current posture in a sequence of motions of a second subject;
an image acquisition unit that acquires, from the moving image, an image corresponding to the current posture; and
a first display control unit that causes a display to display the image acquired by the image acquisition unit.

13. The display control apparatus according to claim 2,
further comprising an image capture unit that sequentially captures the second subject,
wherein the identification unit identifies the current posture of the second subject in images that are sequentially captured by the image capture unit, and
the first display control unit causes the display unit to simultaneously display the image acquired by the image acquisition unit and the image captured by the image capture unit.

14. The display control apparatus according to claim 3,
further comprising an image capture unit that sequentially captures the second subject,
wherein the identification unit identifies the current posture of the second subject in images that are sequentially captured by the image capture unit, and
the first display control unit causes the display unit to simultaneously display the image acquired by the image acquisition unit and the image captured by the image capture unit.

15. The display control apparatus according to claim 4,
further comprising an image capture unit that sequentially captures the second subject,
wherein the identification unit identifies the current posture of the second subject in images that are sequentially captured by the image capture unit, and
the first display control unit causes the display unit to simultaneously display the image acquired by the image acquisition unit and the image captured by the image capture unit.

16. The display control apparatus according to claim 5,
further comprising an image capture unit that sequentially captures the second subject,
wherein the identification unit identifies the current posture of the second subject in images that are sequentially captured by the image capture unit, and
the first display control unit causes the display unit to simultaneously display the image acquired by the image acquisition unit and the image captured by the image capture unit.

17. The display control apparatus according to claim 6,
further comprising an image capture unit that sequentially captures the second subject,
wherein the identification unit identifies the current posture of the second subject in images that are sequentially captured by the image capture unit, and
the first display control unit causes the display unit to simultaneously display the image acquired by the image acquisition unit and the image captured by the image capture unit.

18. The display control apparatus according to claim 7,
further comprising an image capture unit that sequentially captures the second subject,
wherein the identification unit identifies the current posture of the second subject in images that are sequentially captured by the image capture unit, and
the first display control unit causes the display unit to simultaneously display the image acquired by the image acquisition unit and the image captured by the image capture unit.
